(19) United States
(12) Patent Application Publication
(10) Pub. No.: US 2026/0012788 A1
(43) Pub. Date: Jan. 8, 2026

(54) MULTI-FACTOR AUTHENTICATION USING A WEARABLE DEVICE

(71) Applicant: Google LLC, Mountain View, CA (US)

(72) Inventors: Ruofei Du, San Francisco, CA (US); Maksym Dzitsiuk, Oakland, CA (US)

(21) Appl. No.: 19/123,324

(22) PCT Filed: Oct. 27, 2023
(86) PCT No.: PCT/US2023/078016

§ 371 Date: Apr. 22, 2025

Related U.S. Application Data
(60) Provisional application No. 63/381,868, filed on Nov. 1, 2022.

(51) Int. Cl. H04W 12/06; G06F 3/01; G06T 7/70; G06V 20/50; G06V 30/14; H04W 12/33

(52) U.S. Cl. CPC H04W 12/068; G06F 3/012; G06T 7/70; G06V 20/50; G06V 30/14; H04W 12/33

(57) ABSTRACT

According to an aspect, a method includes receiving, by a head-mounted display device, an authentication code associated with multi-factor authentication, receiving image data from an image camera on the head-mounted display device, detecting, by the head-mounted display device, that the image data includes an interface for receiving the authentication code, and displaying, by the head-mounted display device, the authentication code at a location that corresponds to the interface.

### CROSS-REFERENCE TO RELATED APPLICATION

This application claims priority to U.S. Provisional Patent Application No. 63/381,868, filed on Nov. 1, 2022, the disclosure of which is incorporated by reference herein in its entirety.

### BACKGROUND

Multi-factor authentication is an electronic authentication method in which a user is granted access to a computer resource after successfully presenting two or more pieces of evidence to an authentication mechanism. In some examples, especially for short message service (SMS) codes, users may have to read the code on a mobile phone and enter the code on another device.

### SUMMARY

The system provides a technical solution to achieve multi-factor authentication with a wearable device in a secure, reliable manner and may decrease the amount of time for a user to complete the multi-factor authentication while maintaining a relatively high level of security for computer resources protected by multi-factor authentication. The wearable device may receive an authentication code associated with multi-factor authentication, determine a location to display the authentication code, and display the authentication code on the wearable device's display at the determined location. In some examples, the location is determined based on a location of a UI element (e.g., a code entry field) in an interface displayed by a computing device.

In some aspects, the techniques described herein relate to a computer-implemented method including: receiving, by a head-mounted display device, an authentication code associated with multi-factor authentication; receiving image data from an image camera on the head-mounted display device; detecting, by the head-mounted display device, that the image data includes an interface for receiving the authentication code; and displaying, by the head-mounted display device, the authentication code at a location that corresponds to the interface.

In some aspects, the techniques described herein relate to a method including: detecting, by a head-mounted display device, an authentication request; in response to the authentication request, displaying an interface; receiving, via the interface, a plurality of gestures; determining whether the plurality of gestures correspond to a stored pattern of gestures; and in response to the plurality of gestures being determined as corresponding to the stored pattern of gestures, authenticating the authentication request.

The details of one or more implementations are set forth in the accompanying drawings and the description below. Other features will be apparent from the description and drawings, and from the claims.

### BRIEF DESCRIPTION OF THE DRAWINGS

FIG. 1A depicts a system for multi-factor authentication using a wearable device according to an aspect.

FIG. 1B illustrates an example of a wearable device displaying an authentication code according to an aspect.

FIG. 1C illustrates an example of a wearable device displaying an authentication code on an interface of a computing device according to an aspect.

FIG. 1D illustrates an example of an authentication code being displayed in a code entry field of an interface of a computing device according to an aspect.

FIG. 1E illustrates an example of an authentication code being displayed above a code entry field of an interface of a computing device according to an aspect.

FIG. 1F illustrates an example of a wearable device for determining the font size of an authentication code according to an aspect.

FIG. 2A illustrates an example of a wearable device displaying a first portion of an authentication code according to an aspect.

FIG. 2B illustrates an example of a wearable device displaying a second portion of the authentication code according to an aspect.

FIG. 2C illustrates the first portion of the authentication code being aligned with the second portion of the authentication code according to an aspect.

FIG. 3 illustrates an example of a wearable device depicting a gaze interface for multi-factor authentication according to an aspect.

FIG. 4 illustrates an example of an optical label being inserted into a web page for multi-factor authentication according to an aspect.

FIG. 5A illustrates a front view of a head-mounted wearable device according to an aspect.

FIG. 5B illustrates a back view of the head-mounted wearable device according to an aspect.

FIG. 6 illustrates example operations of a system for multi-factor authentication using a wearable device according to an aspect.

### DETAILED DESCRIPTION

This disclosure relates to a system for multi-factor authentication using a wearable device, where the wearable device can receive an authentication code and display at least a portion of the authentication code. The wearable device may be a head-mounted display device. In some examples, the wearable device displays the authentication code at a position (e.g., a 3D position) that corresponds to a position (e.g., a 3D position) of a real-world object (e.g., a UI element on a screen in front of the user). For example, the authentication code is positioned (e.g., attached, anchored) to a particular UI element on an interface displayed by a user device (e.g., the device's interface is in front of the user). For example, the authentication code is anchored to the location regardless of head movements. In some examples, the UI element is a code entry field, and the wearable device displays the authentication code in a position that corresponds to (or is adjacent to) the position of the code entry field. In some examples, the wearable device includes an augmented reality (AR) display device (e.g., smart glasses). In some examples, the wearable device includes a virtual reality (VR) headset. In some examples, while viewing the authentication code on the wearable device, the user may enter the authentication code on the user device.

In some examples, the wearable device receives the authentication code by detecting the authentication code from image data captured by one or more image cameras on the wearable device. The image camera(s) may generate image data about the user's surroundings. In some examples, the wearable device detects the authentication code from the image data using optical text recognition. For example, a user may use a first user device (e.g., laptop) to navigate to a resource protected by multi-factor authentication and enter their login/password information to complete a first verification factor, which may trigger the transmission of an authentication code to a second user device (e.g., the user's smartphone) for completion of a second verification factor. In some examples, instead of transmitting an authentication code, the authentication may be viewable from an authenticator application on the user's smartphone. While the user looks at their smartphone, the wearable device may receive, via the image camera(s), image data of the authentication code displayed on the user's smartphone. From the image data, the wearable detect may extract the authentication code. Although a smartphone and a laptop are used as examples for the first and second user devices, the first and second user devices may be any type of user device such as a tablet, desktop computer, smart watch, gaming console, television device, etc.

In some examples, the wearable device receives the authentication code from the second user device (e.g., smartphone) via a wireless connection (e.g., a direct Wi-Fi connection, a short-range wireless connection (e.g., Bluetooth connection), etc.). In some examples, the wearable device receives the authentication code from a central server. In some examples, the second user device's operating system may detect the authentication code, and the operating system may be associated with a user account that is linked to other devices, including the wearable device. When the wearable device and second user device are associated with the same user account, the wearable device may receive the authentication code from the second user device and/or a central server.

The wearable device may display the authentication code at a location (e.g., a 3D location) that corresponds to a location (e.g., 3D location) of an interface, displayed by the first user device (e.g., laptop), for receiving the authentication code. In some examples, the code's location is based on a location of a particular UI element (e.g., a code entry field, optical label, etc.) in the interface displayed on the first user device. In other words, in some examples, the wearable device may anchor the authentication code to a particular UI element in the interface that is displayed by the first user device.

In some examples, the authentication code is fixedly anchored to the object (e.g., the UI element), where, when the UI element moves, so does the authentication code. For example, when the particular UI element moves to a different location in the user's field of view (e.g., the user moves their head), the authentication code remains fixed to the particular UI element (e.g., moves with the particular UI element). In some examples, the wearable device may overlay the authentication code in the interface's code entry field for receiving the authentication code. In some examples, the wearable device may display the authentication code at a location next to (e.g., above, below, adjacent to, etc.) the code entry field for receiving the authentication code. Then, the user may use the first user device to enter the authentication code in the code entry field (e.g., type the code into the code entry field). In some examples, the wearable device displays the authentication code in the code entry field (e.g., spatially positioning the authentication code into boxes). In some examples, the wearable device may determine the font size of the authentication code based on the depth (e.g., depth value) between the wearable device and the first user device (e.g., how far away the smartphone is away from the wearable device). Then, the user may use the first user device to enter the authentication code.

In some examples, each time a user types a new character, the wearable device causes the character to disappear. In some examples, each time a user types a new character, the wearable device causes a change to a display characteristic of the character (e.g., changes the color, transparency, contrast, etc.). In some examples, if a wrong character is entered, the wearable device may highlight the character (e.g., highlighted in red). In some examples, instead of overlaying the authentication on the interface displayed by the first user device, the wearable device may communicate with a browser application, executing on the first user device, to enter the authentication code into the code entry field.

In some examples, instead of displaying the authentication code on the wearable device, the wearable device may detect an authentication request for multi-factor authentication, and, in response to the authentication request, the wearable device may render a gaze interface. For example, the wearable device may receive, via the gaze interface, a plurality of gaze gestures, determine whether to the gaze gestures correspond to a stored pattern of eye gestures, and, in response to the gaze gestures being determined as corresponding to the stored pattern of eye gestures, the wearable device may authenticate the authentication request, thereby giving access to the underlying computer resource protected by multi-factor authorization.

In some examples, the wearable device receives a first portion of the authentication code and displays the first portion of the authentication code on the wearable device's display. A second portion of the authentication code may be displayed on the first user device. In some examples, when the first portion is aligned with the second portion, the authentication code may be visible to the user. These and other features are further explained with reference to the figures.

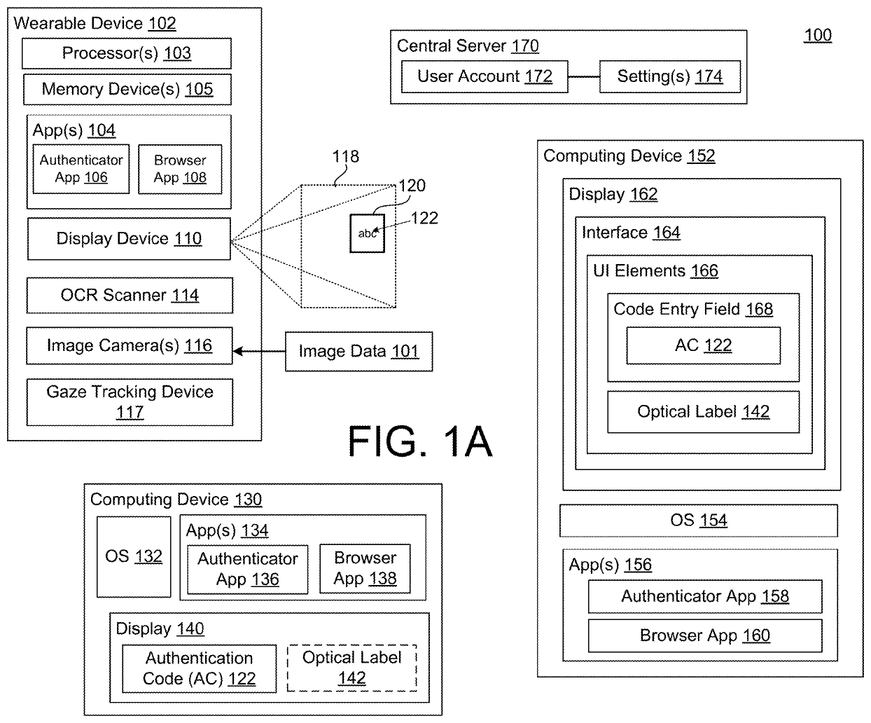

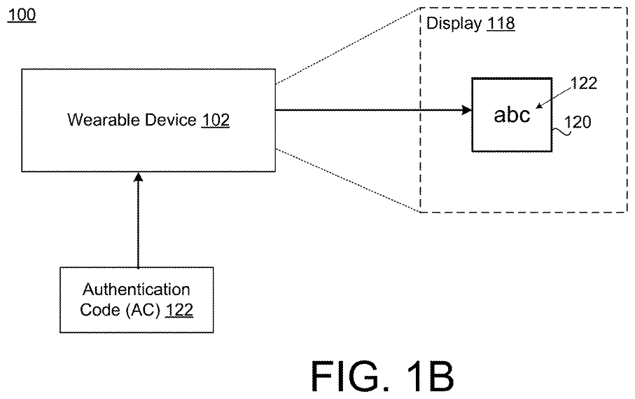

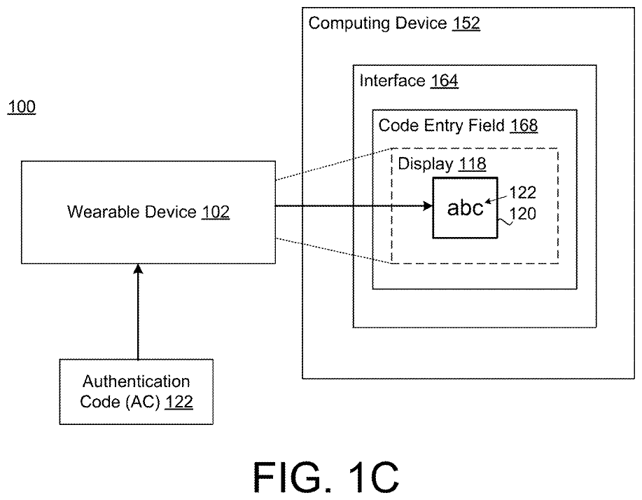

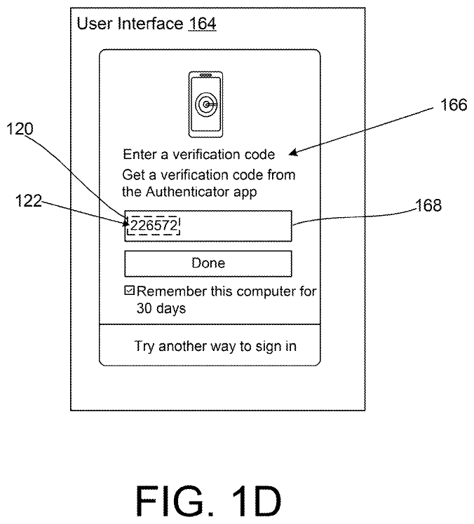

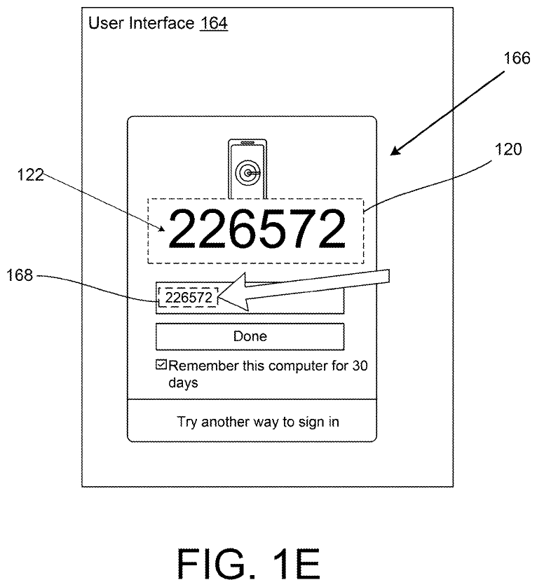

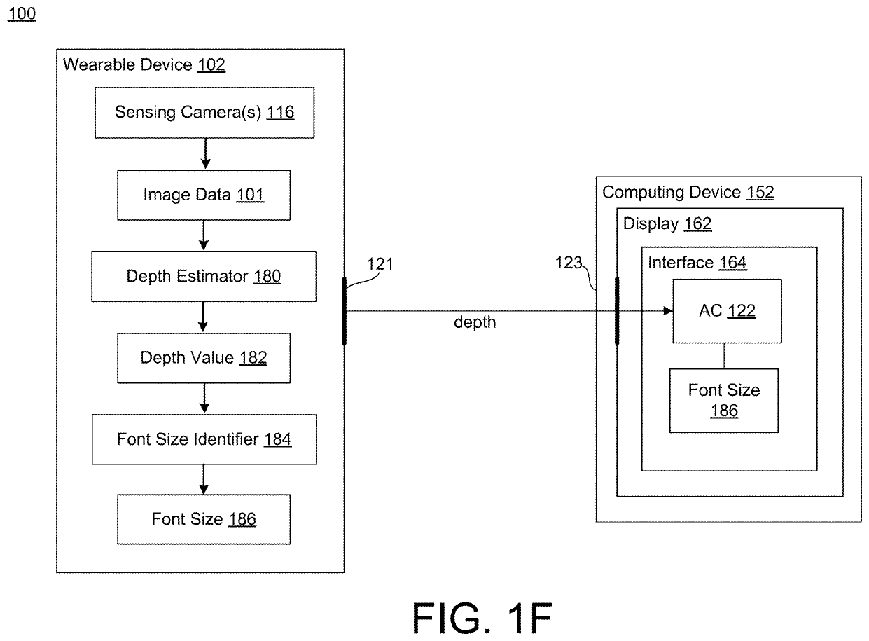

FIGS. 1A through 1F illustrate a system 100 for multi-factor authentication using a wearable device 102 according to various aspects. The wearable device 102 may obtain an authentication code 122 associated with multi-factor authentication (e.g., two-factor authentication, three-factor authentication, or more than three-factor authentication, etc.), determine a location 120 to display the authentication code 122, and, in some examples, display the authentication code 122 on a display 118 of the wearable device 102 at the location 120.

Multi-factor authentication is an authentication method that requires the user to provide two or more verification factors to gain access to a computer resource such as an application, online account, or a virtual private network. In some examples, the verification factors may include receipt of an authentication credential (e.g., a username, account identifier, password, etc.) of the user, receipt of biometric(s) (e.g., fingerprint, facial recognition, iris recognition, voice recognition, etc.) of the user, receipt of an authentication code 122, and/or information indicating a presence of a physical token or smartcard. In some examples, the authentication code 122 is generated in response to successful authentication of a first verification factor (e.g., the user entered the correct username/password, entered a correct pin, etc.).

In some examples, the authentication code 122 is generated by a computer resource, e.g., a web resource (e.g., a web page visited by the user) or an application (e.g., application 104 or application 134) executing on a user device (e.g., computing device 130 or computing device 152). In some examples, the authentication code 122 is transmitted to the user via a message (e.g., a text message or email message). For example, the user may have provided their email address or phone number associated with a particular computer resource that has multi-factor authentication, and, in response to a successful first verification factor, a text message or email (that includes the authentication code 122) is received at the user's device (e.g., computing device 130 or computing device 152).

In some examples, the authentication code 122 is generated by an authenticator application. Separate instances of an authenticator application are represented by an authenticator application 106 (executing on the wearable device 102), an authenticator application 136 (executing on the computing device 130), and/or an authenticator application 158 (executing on the computing device 152). An authenticator application (e.g., 106, 136, 158) may periodically update the authentication code 122 (over time), and, in some examples, the user may view the authentication code 122 from the authenticator application's user interface. For example, when the authenticator application is launched, the authenticator application may display the authentication code 122 associated with a particular computer resource having multi-factor authentication.

In some examples, the underlying computing device (e.g., the operating system) may communicate with the authenticator application to obtain the authentication code 122 (e.g., via an inter-process communication (IPC)), where the authentication code 122 may be provided to other devices, including the wearable device 102 (e.g., devices having an operating system associated with the same user account 172). For example, the wearable device 102 may obtain the authentication code 122 from the authenticator application 106. In some examples, the wearable device 102 may obtain the authentication code 122 from the authenticator application 136 of the computing device 130 when the operating system of the wearable device 102 and the operating system 132 of the computing device 130 are associated with the same user account 172. In some examples, the wearable device 102 may obtain the authentication code 122 from the authenticator application 158 of the computing device 152 when the operating system of the wearable device 102 and the operating system 154 of the computing device 152 are associated with the same user account 172.

The authentication code 122 may include a combination of characters (e.g., numbers, symbols, letters, etc.) that is used to verify the identity of a user. In some examples, the authentication code 122 includes a first character, a second character, a third character, and so forth. In some examples, the authentication code 122 is associated with an order of characters (e.g., the second character must be positioned after the first character).

In further detail, when gaining access to a computer resource associated with multi-factor authentication (e.g., an online account on a web page), a user may use their computing device (e.g., computing device 152) to provide their authentication credential (e.g., username, password) on an interface of the computer resource, which may be considered the first verification factor in the multi-factor authentication. In some examples, in order to gain access to the computer resource, a second verification factor is required. In some conventional approaches, an email or text message is transmitted to the user, where the email or text message includes an authentication code 122. In some examples, the authentication code 122 is generated by the computer resource (e.g., the web page) that hosts the online account. In some examples, the authentication code 122 is generated and displayed by an authenticator application (e.g., authenticator application 136) executing on a mobile device. The user then views the authentication code 122 and enters the authentication code 122 on the online account's web page.

As discussed herein, the system 100 provides a technical solution to achieve multi-factor authentication using a wearable device 102 in a secure, reliable manner. In some examples, the system 100 may decrease the amount of time for a user to complete the multi-factor authentication while maintaining a relatively high level of security for computer resources protected by multi-factor authentication.

The wearable device 102 may include a head-mounted display (HMD) device such as an optical head-mounted display (OHMD) device, a transparent heads-up display (HUD) device, an augmented reality (AR) device, a virtual reality (VR) device, or other devices such as goggles or headsets having sensors, display, and computing capabilities. In some examples, the wearable device includes an AR device. In some examples, the wearable device includes smart glasses. Smart glasses is an optical head-mounted display device designed in the shape of a pair of eyeglasses. Smart glasses may be glasses that add information (e.g., project a display 118) alongside what the wearer views through the glasses (e.g., the wearer may view an interface 164 for receiving the authentication code 122 via the glasses). Smart glasses may allow a user to see physical items in the world (e.g., through the lenses) and content (e.g., the authentication code 122, digital images, user interface elements, virtual content, and the like) rendered in the display 118.

In some examples, the wearable device 102 includes a VR device that provides a partial (or fully) immersive VR environment. A VR device is a head-mounted display (HMD) that creates a simulated environment for the user. AR devices may be eyewear or handheld devices that use cameras and sensors to track the user's surroundings. AR devices can display digital information, such as directions, product information, or even virtual characters and objects, on top of the real world. VR devices are typically headsets that completely block out the real world and replace it with a virtual one. However, VR devices may include image camera(s) 116 that capture image data 101 in front of the user (or surround or partially surround the user). VR devices use sensors to track the user's head movements and adjust the virtual environment accordingly. An extended reality (XR) device may encompass a VR device and an AR device. In some examples, an XR device has two screens, one for each eye. The screens display slightly different images, which creates the illusion of depth. An XR device also has sensors that track the user's head movements, so that the virtual environment can move with the user's head.

The wearable device 102 includes one or more processors 103 and one or more memory devices 105. The processor(s) 103 may be formed in a substrate configured to execute one or more machine executable instructions or pieces of software, firmware, or a combination thereof (e.g., to execute any of the operations discussed herein with respect to the wearable device 102). The processor(s) 103 can be semiconductor-based—that is, the processors can include semiconductor material that can perform digital logic. The memory device(s) 105 may include a non-transitory computer-readable medium that stores executable instructions that causes the processor(s) 103 to perform the operations discussed herein with respect to the wearable device 102. In some examples, the memory device(s) 105 may include main memory that stores information in a format that can be read and/or executed by the processor(s) 103. The memory device(s) 105 may store applications 104 that, when executed by the processors 103, perform certain operations.

In some examples, the applications 104 include an authenticator application 106. The authenticator application 106 may periodically generate an authentication code 122. For example, the authenticator application 106 may be enabled with respect to a particular computer resource that implements multi-factor authentication, and, in some examples, the authenticator application 106 may periodically update the authentication code 122 (e.g., changes the authentication code 122 every predetermined period of time) for that particular computer resource.

The wearable device 102 may include a display device 110 configured to project a display 118 in the field of view of the user. In some examples, the display device 110 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see content (e.g., the authentication code 122, digital images, user interface elements, virtual content, authentication code 122, etc.) that is generated by the display device 110 at locations next to (or superimposed on) physical items in the world, for example, seen through the lenses (e.g., an interface 164 displayed on another computing device such as computing device 152).

The wearable device 102 includes one or more image cameras 116. The image camera(s) 116 generate image data 101 of a physical scene in the camera's field of view. In some examples, in the case of an AR device, the user's field of view (as seen through the glasses) may correspond to the camera's field of view. In some examples, in the case of an AR device, the camera's field of view is greater or less than the user's field of view. The image cameras 116 may capture what is displayed by the computing device 130 or the computing device 152 when their display screen is within the image camera's field of view. The image camera(s) 116 may include cameras such as forward facing cameras, outward, or world facing cameras, and the like that can capture still and/or moving images of an environment outside of the wearable device 102. In some examples, the wearable device 102 is a VR device, and the image cameras 116 may capture the world in front of the user, including what is displayed by the computing device 130 or the computing device 152. In some examples, the wearable device 102 may generate and display a computer-generated representation of a user device (e.g., computing device 130, computing device 152) when the user device is within the image camera's field of view, including computer-generated graphics that corresponds to what is displayed on its display screen.

The wearable device 102 may include other sensors such as one or more position/orientation sensor(s) (e.g., an inertial measurement unit, an accelerometer, a gyroscope, and/or a magnetometer, etc.), one or more audio sensors that can detect audio input, one or more touch input sensors that can detect touch inputs, and other such sensors. In some examples, the wearable device 102 includes a gaze tracking device 117 to detect and track eye gaze direction and movement. Data captured by the gaze tracking device 117 may be processed to detect and track gaze direction and movement as a user input.

The computing device 152 may be a laptop computer. In some examples, an operating system 154 of the computing device 152 is a desktop operating system. In some examples, the operating system 154 of the computing device 152 is a mobile operating system. However, the computing device 152 may be any type of user device such as a smartphone, a tablet, a desktop computer, a gaming console, another wearable device, etc. The computing device 152 is configured to execute application 156. The applications 156 may include an authenticator application 158 and a browser application 160. However, the applications 156 may include a wide variety of applications such as native applications (e.g., installable on the operating system 154), web applications (e.g., executable at least in part by a browser application 160), mobile applications (e.g., executable in a mobile environment), and desktop applications (e.g., executable in a desktop environment), etc. The authenticator application 158 and the browser application 160 may be separate instances of the authenticator application 106 and the browser application 108, respectively, and, therefore, may include any of the details discussed with reference to those components.

A user may use the computing device 152 to access a computer resource associated with (e.g., protected by) multi-factor authentication. In some examples, the computer resource is one of the applications 156. In some examples, the computer resource is accessible via the browser application 160. In some examples, the computer resource is a web page, an online account, or web application. In some examples, in a first verification factor, the user may provide their authentication credential (e.g., submit their username/password), which causes initiation of a second verification factor. In some examples, the second verification factor includes notifying the user of the authentication code 122, where the authentication code 122 is submitted via a code entry field 168 of an interface 164 on a display 162 of the computing device 152.

As shown in FIG. 1A, in some examples, the authentication code 122 may be displayed on a display 140 of another computing device, e.g., computing device 130. In some examples, the computing device 130 is a user device that is linked to the computer resource protected by multi-factor authentication. In some examples, the computing device 130 is a user device configured to generate or receive an authentication code 122 when the user correctly supplies their authentication credential using the computing device 152. The computing device 130 may be a mobile device such as a smartphone or a tablet computer. In some examples, an operating system 132 of the computing device 130 is a mobile operating system.

However, the computing device 130 may be any type of user device such as a laptop, desktop computer, a gaming console, another wearable device, etc. The computing device 130 is configured to execute applications 134. The applications 134 may include an authenticator application 136 and a browser application 138. However, the applications 134 may include a wide variety of applications such as native applications (e.g., installable on the operating system 132), web applications (e.g., executable at least in part by a browser application 138), mobile applications (e.g., executable in a mobile environment), and desktop applications (e.g., executable in a desktop environment), etc. The authenticator application 136 and the browser application 138 may be separate instances of the authenticator application 106 and the browser application 108, respectively, and, therefore, may include any of the details discussed with reference to those components.

In some examples, the computing device 130 receives a message (e.g., a text message or an email), where the message includes the authentication code 122. The authentication code 122 may be generated by the computer resource protected by multi-factor authentication. For example, in response to a successful first verification factor, the computing device 130 may receive and display the authentication code 122. In some examples, in response to a successful first verification factor, a user may use the computing device 130 to launch the authenticator application 136, which displays the authentication code 122 on the display 140 of the computing device 130. In some examples, the authenticator application 136 is a native (e.g., mobile) application installed on the operating system 132 of the computing device 130.

In some examples, the wearable device 102 may receive, via the image camera(s) 116, image data 101 of the authentication code 122. For example, the user may move the wearable device 102 such that the authentication code 122, displayed on the display 140 of the computing device 130, is within the field of view of the image camera(s) 116. The wearable device 102 may include an optical character recognition (OCR) scanner 114 configured to extract the authentication code 122 from the image data 101 using OCR techniques. The OCR scanner 114 is configured to recognize text (e.g., the authentication code 122) within the image data 101 captured by the image camera(s) 116. In some examples, the OCR scanner 114 is configured to recognize and detect authentication codes 122 (e.g., not other textual information that may be captured by the image cameras 116). When the authentication code 122 is displayed (e.g., via a text message, email, or displayed by the authenticator application 136), the user with the wearable device 102 may turn to the computing device 130 causing the display 140 of the computing device to be within a field of view of the image camera(s) 116. The wearable device 102 may use other image detection and recognition techniques for detecting the authentication code 122. In some examples, the wearable device 102 includes a machine learning (ML) model (e.g., a neural network model). The ML model can be configured to identify and extract an authentication code 122 from image data 101.

In some examples, instead of using text recognition from image data 101, the wearable device 102 may receive the authentication code 122 from the computing device 130 via a wireless connection between the wearable device 102 and the computing device 130. In some examples, the wearable device 102 and the computing device 130 may be wirelessly connected. In some examples, the wireless connection is a direct Wi-Fi connection or a short-range communication link such as near-field communication (NFC) connection or Bluetooth connection. The wearable device 102 and the computing device 130 may exchange information via the wireless connection. In some examples, the wireless connection defines an application-layer protocol that is implemented using protocol buffers with message types for drawing graphic primitives, configuring sensors and peripherals, and changing device modes. In some examples, when a message (e.g., text message) is received at the computing device 130, the message is transferred to the wearable device 102 via the application-layer protocol. In some examples, the wearable device 102 and the computing device 130 are devices that are associated with the same user account 172, e.g., a browser application, an operating system account, authentication account, or other type of user account 172. In some examples, the wearable device 102 may receive the authentication code 122 from the computing device 130 via a central server 170.

If the authentication code 122 is received or generated by the computing device 152, the wearable device 102 may obtain the authentication code 122 from the computing device 152 in the same manner as explained with reference to the computing device 130. For example, the computing device 130 may receive a message (e.g., text or email) from the computer resource protected by multi-factor authentication and display the authentication code 122 on the display 162, where the wearable device 102 obtains the authentication code 122 via OCR scanning. In some examples, the authenticator application 158 may generate and display the authentication code 122, where the wearable device 102 obtains the authentication code 122 via OCR scanning. In some examples, the computing device 152 and the wearable device 102 are connected via a wireless connection, and the wearable device 102 obtains the authentication code 122 via the wireless connection.

In some examples, the wearable device 102 may receive the authentication code 122 from a central server 170 (e.g., also referred to as a server or a server computer). In some examples, the wearable device 102, the computing device 152, and/or the computing device 130 are connected to each other via a network (e.g., the Internet). In some examples, the operating system 154 (and/or the browser application 160) may be associated with a user account 172, and the wearable device 102 and/or the computing device 130 may be devices that are linked to the user account 172 (e.g., devices that are identified in the user account 172). In some examples, if the computer resource protected by multi-factor authentication is managed or owned by an entity that manages or owns the operating system 154 (and/or the browser application 160), the wearable device 102 may obtain the authentication code 122 from the central server 170. In some examples, if the computer resource protected by multi-factor authentication is managed or owned by an entity that manages or owns the operating system 132 (and/or the browser application 138), the wearable device 102 may obtain the authentication code 122 from the central server 170.

Referring to FIG. 1B, in response to the authentication code 122 being detected, in some examples, the wearable device 102 may display the authentication code 122 in the display 118 of the wearable device 102. In some examples, the location 120 is dependent on the image data 101 generated by the image camera(s) 116 (e.g., viewed through the lens) (e.g., the objects in front of the user). In some examples, the wearable device 102 may display the authentication code 122 at a location 120, which does not depend on information in front of the user (e.g., as captured by the image data 101). In some examples, the wearable device 102 determines a location 120 to display the authentication code 122 and displays the authentication code 122 at the location 120. In some examples, the location 120 includes two-dimensional coordinates (e.g., x, y). In some examples, the location 120 includes three-dimensional coordinates (e.g., x, y, z). In some examples, the location is a predetermined location such as a position in the top (or bottom) portion of the display 118. In some examples, the location 120 is a position in the left (or right) portion of the display 118. In some examples, the location 120 is a position in the central portion of the display 118. In some examples, the location 120 based on the location (or position) of an object in the image data 101.

In some examples, the location 120 is fixed (e.g., does not change) in the display 118. In some examples, the location 120 in the display 118 may change (e.g., move), which depends on the image data 101 in the image camera's field of view. In some examples, the location 120 is based on which content is currently projected by the display device 110 (e.g., other computer generated elements displayed in the display 118). In some examples, the location 120 is not determined based on currently displayed content.

In some examples, the wearable device 102 may display the authentication code 122 at a location 120 in the display 118, where the location 120 is based on an interface 164 for receiving the authentication code 122. In some examples, the location 120 is a particular object (e.g., a UI element) in the image data 101. In some examples, the authentication code 122 is anchored to or coupled to the particular object. In some examples, the location 120 is based on a location of a particular UI element 166 in the interface 164. In some examples, the wearable device 102 may anchor (e.g., fixedly coupled) the authentication code 122 to a particular UI element 166 in the display 162 of the computing device 152. In other words, the authentication code 122 may remain fixed to the particular UI element 166 regardless of head movements. The wearable device 102 may include one or more inertial measurement units (IMUs) configured to track the movement of the wearable device 102, which may be used to align the authentication code 122 with the UI element 166. In some examples, in response to the first verification factor being successful, the computing device 152 may render an interface 164 for receiving the authentication code 122.

The interface 164 may be a user interface of an application 156 executing on the computing device 152. In some examples, the interface 164 is an interface of a browser application 160. In some examples, the interface 164 includes a web page displayed by the browser application 160. The interface 164 may include one or more UI elements 166. The UI elements 166 may include field entry field(s) (e.g., a code entry field 168 for receiving the authentication code 122), an optical label 142, menu items, user controls elements, border of interface, navigation panel, etc. In some examples, the authentication code 122 is displayed in or next to the UI element 166 and may remain displayed in or next to the UI element 166 despite the UI element 166 moving to a different area in the display 118. For example, the UI element 166 may be located in a right portion of the display 118, and the user may move their head to the right (or the computing device 152 to the left), which shifts the UI element 166 to a left portion of the display 118. The authentication code 122 may remain fixed to the UI element 166 despite the UI element's movement in the display 118.

In some examples, the wearable device 102 may display a computer-generated representation of the computing device 130 in the display 118 in a location that corresponds to its location in front of the user. Also, the wearable device 102 may generate and display content (e.g., VR content) that corresponds to what is displayed on the display screen of the computing device 130, including the display of the authentication code 122 (which may be displayed via a text message, an email, or an authenticator application 136). In some examples, the wearable device 102 may display the interface 164 for receiving the authentication code 122. In some examples, the user can interact with the authentication code 122 (e.g., pinch the authentication code 122) and drag it to the interface 164.

The wearable device 102 may determine the location 120 for displaying the authentication code 122 in the display 118 of the wearable device 102 based on the interface 164 (e.g., the structure of the interface 164 and/or positions of the UI elements 166 of the interface 164). In some examples, the location 120 is based on a location of a particular UI element 166 (e.g., the code entry field 168, optical label 142) in the interface 164. In other words, in some examples, the wearable device 102 may associate (e.g., anchor, attach) the location 120 of the authentication code 122 to a particular UI element 166 in the display 162 of the computing device 152.

In some examples, the wearable device 102 may detect that the image data 101 includes the UI element 166 (e.g., the code entry field 168). In some examples, the UI element 166 refers to the interface for receiving the authentication code 122. For example, the wearable device 102 may include an image detection and recognition engine configured to detect a certain type of physical object (e.g., the UI element 166) based on the image data 101. In some examples, the wearable device 102 includes one or more ML models configured to detect a UI element 166. The wearable device 102 may include a 3D estimation engine configured to determine a position (e.g., a 3D position) of the UI element 166 in 3D space based on the image data 101. In some examples, the image data 101 includes a pair of stereo images, and the 3D estimation engine may estimate the 3D position of the UI element 166 using the pair of stereo images (e.g., by computing a disparity between the UI element 166 in the stereo images). In some examples, the 3D estimation engine may use depth sensors to compute the depth and locations of objects in front of the user.

The wearable device 102 may identify a particular UI element (e.g., the code entry field 168) from the image data 101 or by examining the optical label 142 and may determine the location 120 based on the location of the UI element. In some examples, the computing device 152 displays an optical label 142 (e.g., a QR code) that corresponds to the interface 164. An optical label is a machine-readable label that can be read by a computing device and is used to store a resource locator (e.g., URL) of a web resource. In some examples, the optical label 142 includes bar code (e.g., a two-dimensional barcode). In some examples, the optical label 142 includes a QR code. In some examples, the optical label 142 includes a pixel pattern (e.g., black and white pixel pattern). In some examples, the optical label 142 includes a machine-readable optical label. The wearable device 102 may obtain, via the image camera(s) 116, the optical label 142 corresponding to the interface 164. The optical label 142 may represent a resource locator (e.g., URL) of a computer resource (e.g., the interface 164). In some examples, when the optical label 142 is interpreted, the interface 164 is rendered. The wearable device 102 may use the resource locator to obtain information about the UI elements 166 (e.g., what UI elements are included, where they are located, etc.). In some examples, the wearable device 102 may obtain, via the image camera(s) 116, image data 101 of the UI elements 166 on the interface 164 and determine the location 120 of the authentication code 122 using the image data 101.

Referring to FIGS. 1C and 1D, the wearable device 102 may display the authentication code 122 in the code entry field 168 on the interface 164 that is displayed by the computing device 152. For example, the wearable device 102 may overlay (e.g., superimpose) the authentication code 122 in the code entry field 168 on the interface 164 displayed by the computing device 152. In other words, the values of the authentication code 122 may not be entered into the code entry field 168, but the wearable device 102 projects the authentication code 122 in a location on top of the code entry field 168. Then, the user may use the computing device 152 to enter (e.g., manually enter) the authentication code 122 in the code entry field 168. In some examples, the wearable device 102 renders the interface 164 on the display 118 and the wearable device 102 displays the characters of the authentication code 122 in the code entry field 168. In some examples, the interface 164 is not displayed in the display 118, and the wearable device 102 sends the authentication code 122 to the underlying resource to authenticate the user.

Referring to FIG. 1E, the wearable device 102 may display the authentication code 122 in a location 120 that is outside the code entry field 168. In some examples, the authentication code 122 is anchored to an optical label 142, where the authentication code 122 is overlaid (e.g., superimposed) on the optical label 142, which may be proximate to (but outside a border of) the code entry field 168. In some examples, the authentication code 122 may be displayed in the display 118 at a location 120 above the code entry field 168. Then, the user may use the computing device 152 to enter the authentication code 122 in the code entry field 168. In some examples, each time a user types a new character, the wearable device 102 causes the character to disappear. In some examples, as a user correctly types a new character, a display characteristic of the character changes (e.g., color, transparency, color, etc.). In some examples, if a wrong character is entered, the wearable device 102 may highlight the character (e.g., highlighted in red).

The wearable device 102 may cause the computing device 152 to enter (and, in some examples, submit) the authentication code 122 in the code entry field 168, where the user does not have to type the authentication code 122 into the code entry field 168. For example, the wearable device 102 may transmit the authentication code 122 to the browser application 160, where the browser application 160 may render the authentication code 122 in the code entry field 168 on the interface 164. In some examples, the wearable device 102 may transmit the authentication code 122 to the computing device 152, and the computing device 152 may automatically enter the authentication code 122.

Referring to FIG. 1E, the wearable device 102 may determine the font size 186 of the authentication code 122 based on the depth (e.g., depth value 182) between a portion 121 of the wearable device 102 and a portion 123 of the computing device 152. In some examples, the portion 121 of the wearable device 102 may be the lens, the image camera(s) 116 or a front portion of the wearable device 102. In some examples, the portion 123 of the computing device 152 is the display screen (e.g., the display 162) of the computing device 152. In some examples, the portion 123 is the code entry field 168 on the display 162 of the computing device 152. For example, the wearable device 102 may receive, via the image camera (a) 116, image data 101 of at least a portion of the computing device 152. The wearable device 102 may include a depth estimator 180 configured to estimate a depth value 182 between the portion 121 of the wearable device 102 and the portion 123 of the computing device 152. In some examples, the depth estimator 180 may estimate the depth value 182 based on one or more images (e.g., RGB images) of the portion 123 of the computing device 152. The wearable device 102 includes a font size identifier 184 configured to identify the font size 186 based on the depth value 182. For example, one or more depth values 182 (or a range of depth values 182) may be associated with a particular font size 186 and one or more depth values (or a range of depth values 182) may be associated with another font size 186. By identifying the depth value 182, the wearable device 102 may select a particular font size 186 for the authentication code 122.

In some examples, the wearable device 102 may derive the authentication code 122 from the authenticator application 106 executing on the wearable device 102, determine a location 120 to display the authentication code 122, and display the authentication code 122 on the display 118 of the wearable device 102 at the location 120. For example, the wearable device 102 may detect an authentication request for multi-factor authentication, and, in response to the authentication request, the wearable device 102 may launch and execute the authenticator application 106 and obtain the authentication code 122 from the authenticator application 106 executing on the wearable device 102. In some examples, the authenticator application 106 may execute in the background of the wearable device 102.

In some examples, the authentication request is a request to retrieve an authentication code 122. In some examples, the authentication request does not include the authentication code 122, where the authenticator application 106 on the wearable device 102 generates the authentication code 122. In some examples, the authentication request includes the authentication code 122.

In some examples, the wearable device 102 may receive an authentication request for multi-factor authentication from the computing device 152. In some examples, the computing device 152 may be a user device that originated the request to access to the computer resource protected by multi-factor authentication (e.g., executed the first verification factor). In some examples, the wearable device 102 and the computing device 152 may be connected to the same network (e.g., same Wi-Fi network). In some examples, the wearable device 102 and the computing device 152 may be connected via a wireless connection (e.g., a direct Wi-Fi connection. a short-range connection, etc.) or a wired connection. In some examples, if the wearable device 102 and the computing device 152 are connected to each other or are on the same Wi-Fi network, the computing device 152 may transmit the authentication request to the wearable device 102.

For example, in response to a successful first verification factor on the computing device 152, the computing device 152 may transmit the authentication request to the wearable device 102. In some examples, the wearable device 102 may receive an authentication request for multi-factor authentication from a central server 170 that includes information about a user account 172 associated with one or more linked devices (e.g., computing device 130, a computing device 152, and/or a wearable device 102). In some examples, the user account 172 is a user account of an operating system. In some examples, the user account 172 is a user account of a browser application. The user account 172 may be associated with settings 174. If the user account 172 is associated with an operating system, the settings 174 may include network settings, display settings, application settings, multi-factor authentication settings, etc. If the user account 172 is associated with a browser application, the settings 174 may include multi-factor authentication settings, browser settings, personalization settings, etc.

In some examples, the wearable device 102 may receive, via image camera(s) 116, image data 101, where the image data 101 includes an optical label 142 (e.g., a barcode, a QR code, etc.) that is associated with a multi-authentication authority. In some examples, in response to the detection of the optical label 142 in the image data 101, the wearable device 102 may detect the authentication request.

In some examples, the applications 104 include a browser application 108. The browser application 108 may be a web browser configured to access information on the Internet. In some examples, the browser application 108 is a separate application from the operating system of the wearable device 102, where the browser application 108 is installable on (and executable by) the operating system. In some examples, the browser application 108 is the device's operating system (or included as part of the device's operating system). The browser application 108 may launch one or more browser tabs in the context of one or more browser windows on a display 118 of the wearable device 102.

In some examples, in response to the wearable device 102 receiving the authentication code 122, the wearable device 102 may render an interface (e.g., interface 164) on the display 118 using the browser application 108 and position the authentication code 122 in a code entry field (e.g., code entry field 168) on the interface. The user may operate the wearable device 102 (e.g., manipulate one or more controls on the wearable device 102) to accept the authentication code 122. In some examples, user interaction is not required on the wearable device 102, where, in response to receiving the authentication code 122, the wearable device 102 may submit the authentication code 122 to the computer resource (e.g., via the browser application 108). The wearable device 102 may generate and transmit information to the computing device 152 that indicates that the second verification factor is successful, which causes the computing device 152 to provide access to the computer resource protected by multi-factor authorization. In some examples, the wearable device 102 may render access to the computer resource (e.g., web page, application 104, etc.) by displaying the computer resource in the display 118 of the wearable device 102.

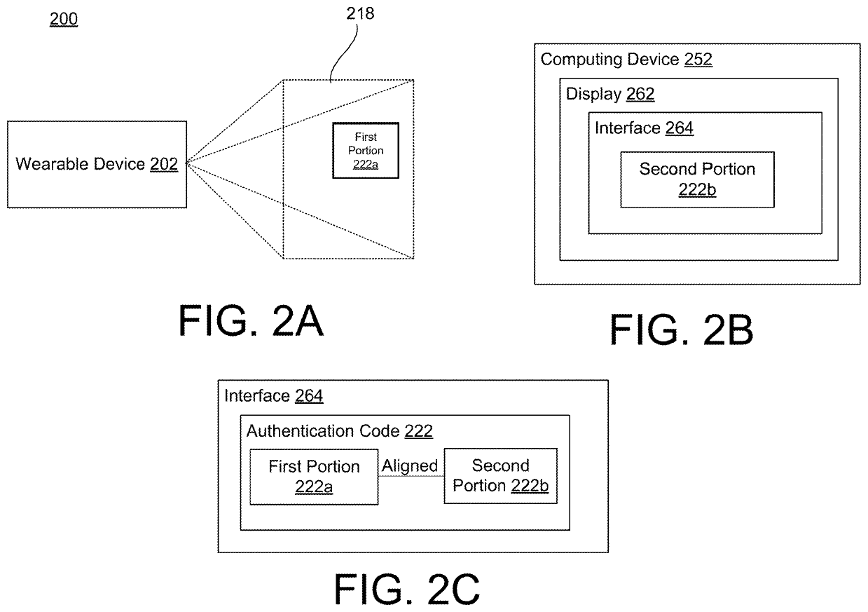

FIGS. 2A through 2C illustrate an example of a system 200 for multi-factor authentication using a wearable device 202 according to another aspect. The system 200 may be an example of the system 100 of FIGS. 1A to 1F and may include any of the details discussed with reference to those figures. In some examples, the system 200 may display a first portion 222a of the authentication code 222 on a display 218 of the wearable device 202 and display a second portion 222b of the authentication code 222 on a display 262 of a computing device 252. When the first portion 222a is aligned with the second portion 222b, the authentication code 222 may be revealed (e.g., visible to the user). In some examples, the wearable device 202 receives the first portion 222a and the second portion 222b from different sources. In some examples, the first portion 222a being aligned with the second portion 222b includes arranging the first portion 222a and the second portion 222b to be adjacent to each other. In some examples, the first portion 222a being aligned with the second portion 222b includes superimposing the first portion 22a on the second portion 222b (or vice versa). In some examples, viewing the first portion 222a and the second portion 222b separately does not reveal the actual character string, but, when the first portion 222a is disposed on top of the second portion 222b, the authentication code 222 is discernible by the user.

The wearable device 202 may receive only the first portion 222a of the authentication code 222. The first portion 222a may be detected according to any of the techniques discussed herein for detecting an authentication code. In some examples, the wearable device 202 may receive the first portion 222a from a central server. In some examples, the wearable device 202 may receive the first portion 222a from the computing device 252. In some examples, the wearable device 202 may receive the first portion 222a from an authenticator application executing on the wearable device 202. In some examples, the wearable device 202 may receive the first portion 222a from a computer resource protected by multi-factor authentication.

The wearable device 202 may project the first portion 222a on the display 218. The computing device 252 may receive the second portion 222b and display the second portion 222b of the authentication code 222 on the interface 264. In some examples, the computing device 252 may receive the second portion 222b from the central server. In some examples, the computing device 252 may receive the second portion 222b from the computer resource protected by multi-factor authentication. In some examples, the central server detects an authentication request for multi-factor authentication, generates the first portion 222a and the second portion 222b, and transmits the first portion 222a and the second portion 222b to the wearable device 202 and the computing device 252, respectively. In some examples, the wearable device 202 receives the authentication code 222 (e.g., according to any of the techniques discussed herein) and generates the first portion 222a and the second portion 222b and transmits the second portion 222b to the computing device 252.

The first portion 222a may represent at least a portion of the authentication code 222. The second portion 222b may represent at least a portion of the authentication code 222. In some examples, both the first portion 222a and the second portion 222b are required to recover the authentication code 222. In some examples, when the first portion 222a is not aligned within the second portion 222b, the authentication code 222 is not discernible by the user (e.g., remains hidden). In some examples, the first portion 222a includes some of the values of the characters of the authentication code 222 and the second portion 222b includes the other values of the authentication code 222. In some examples, the first portion 222a includes a plurality of characters (e.g., arranged in a line, a grid, or matrix) and/or character receptors (e.g., box, underlines, etc.) and the second portion 222b includes a plurality of characters and/or character receptors (e.g., boxes, underlines, etc.), where at least a portion of the first portion 222a would have to be correctly aligned with at least a portion of the second portion 222b (e.g., the first portion 222a may be “_35_” and the second portion 222b may be “3_9” for code 3359). In some examples, the first portion 222a includes the authentication code 222 (or a portion thereof) configured in a first display format, and the second portion 222b includes the authentication code 222 (or a portion thereof) configured in a second display format.

In some examples, the first portion 222a and the second portion 222b have different transparencies (e.g., transparency values). For example, a first transparency level (e.g., not transparent) may indicate that the illumination of a portion of the authentication code 222 is not transparent (e.g., the background image does not show through the image data), and a second transparency level (e.g., fully transparent) may indicate that the illumination of a portion of the authentication code 222 is fully transparent (e.g., hidden, where the background image shows through the image data). In some examples, each of the first portion 222a and the second portion 222b has a transparency value between the first transparency level and the second transparency level. In other words, the first portion 222a and the second portion 222b may have different partial transparency levels.

When the user moves the wearable device 202 to align the first portion 222a (e.g., displayed in the display 218 of the wearable device 202) with the second portion 222b (e.g., displayed in the display 262 of the computing device 252), the authentication code 222 is revealed. In some examples, alignment of the first portion 222a with the second portion 222b includes positioning the first portion 222a at a location that is next to the second portion 222b. In some examples, the alignment of the first portion 222a with the second portion 222b includes positioning the first portion 222a at a location on top of the second portion 222b (e.g., at least partially overlapping (or fully overlapping) on top of each other). In some examples, the user does not have to move the wearable device 202 to align the first portion 222a with the second portion 222b. For example, the wearable device 202 may detect the location to display the first portion 222a in the display 262 by examining the image data 101 of second portion 222b or by examining the optical label 142 and may display the first portion 222a in the correct location that aligns with the second portion 222b, so that the authentication code 222 is revealed.

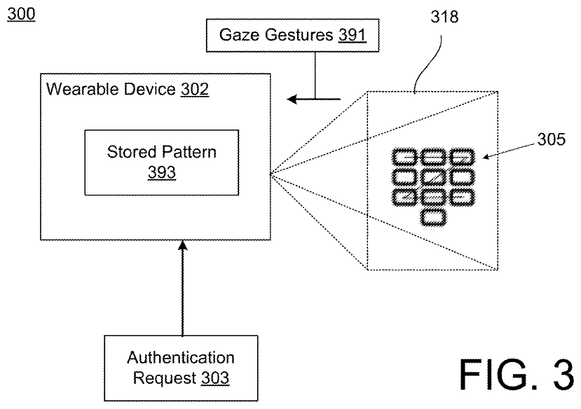

FIG. 3 illustrates an example of a system 300 for multi-factor authentication using a wearable device 302 according to an aspect. The system 300 may be an example of the system 100 of FIGS. 1A to 1F and may include any of the details discussed with reference to those figures. In some examples, the wearable device 302 may detect an authentication request 303, and, in response to the authentication request 303, may display a gaze interface 305 on a display 318 of the wearable device 302. In some examples, the authentication request 303 may correspond to a second verification factor of the multi-factor authentication. In some examples, the authentication request 303 is sent to the wearable device 302 in response to a successful first verification factor. In some examples, the first verification factor is executed on the wearable device 302. In some examples, the first verification factor is executed on another computing device (e.g., computing device 130 or computing device 152 of FIGS. 1A to 1F). In some examples, the authentication request 303 may correspond to a first verification factor, where, when authenticated (e.g., gaze gestures match the stored pattern), causes execution of a second verification factor in which an authentication code 322 is generated and then displayed/entered into an interface.

In some examples, the wearable device 302 may receive the authentication request 303 from another computing device (e.g., computing device 130 or computing device 152 of FIGS. 1A to 1F). In some examples, the wearable device 302 may receive the authentication request 303 from a central server (e.g., the central server 170 of FIGS. 1A to 1F). In some examples, the wearable device 302 may receive, via image camera(s), image data, where the image data includes an optical label (e.g., a barcode, a QR code, etc.) that is associated with a multi-authentication authority. In some examples, in response to the detection of the optical label in the image data, the wearable device 302 may detect the authentication request 303. In some examples, the wearable device 302 may detect an authentication code according to any of the techniques discussed with reference to the previous description, including OCR scanning. In some examples, instead of displaying the authentication code, the wearable device 302 may display the gaze interface 305.

The wearable device 302 may track the trace (e.g., unistroke) of eye movement, and, if the trace matches a certain percentage of the pre-encoded eye gestures (e.g., a stored pattern 393 of eye gestures), the wearable device 302 may verify the second verification factor, thereby giving the user access to the underlying computer resource associated with the multi-factor authentication. For example, the wearable device 302 may receive, via the gaze interface 305, a plurality of gaze gestures 391, determine whether the gaze gestures 391 correspond to a stored pattern 393 of eye gestures, and, in response to the gaze gestures 391 being determined as corresponding to the stored pattern 393 of eye gestures, the wearable device 302 may authenticate the authentication request 303, thereby giving access to the underlying computer resource protected by multi-factor authorization. In some examples, instead of eye gaze gestures, head gestures may be used. For example, the wearable device 302 may receive, via an interface, a plurality of gestures (e.g., eye gestures or head gestures), determine whether the gestures correspond to a stored pattern of gestures (e.g., eye gestures or head gestures), and, in response to the gestures being determined as corresponding to the stored pattern of gestures, the wearable device 302 may authenticate the authentication request 303, thereby giving access to the underlying computer resource protected by multi-factor authorization.

In some examples, instead of an eye gaze interface, the wearable device 302 may display an interface that can accept an authentication code based on head movements. For example, the wearable device 302 may use cameras or sensors to track the movement of the head, and the data from the head tracking devices can be used to calculate the head gaze point. The user may move their head to select different regions corresponding to different character values (e.g., a character value may be selected when the head gaze point is detected within a particular region over a predetermined period of time or in response to a further user selection (e.g., presses a button on the wearable device 302). Using head movements, the user may enter the authentication code in the interface. In some examples, the authentication code may be received by the wearable device 302 according to any of the techniques discussed herein. In some examples, the authentication code is a pre-stored code (e.g., previously determined by the user, and, in some examples, stored at the wearable device 302. When the user enters this code in the interface, the user may be authenticated.

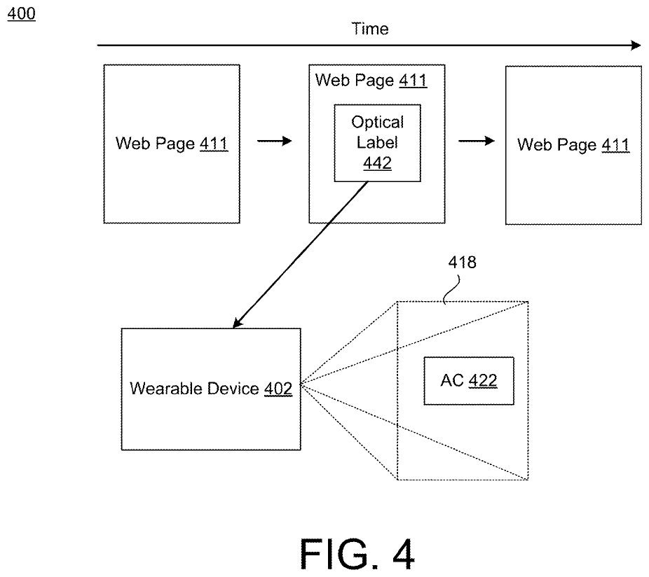

FIG. 4 illustrates an example of a system 400 for multi-factor authentication using a wearable device 402 according to another aspect. The system 400 may be an example of the system 100 of FIGS. 1A to 1F, the system 200 of FIGS. 2A to 2C, and/or the system 300 of FIG. 3 and may include any of the details discussed with reference to those figures.

In some examples, a web page 411 may be displayed on another computing device (e.g., computing device 130 or computing device 152 of FIGS. 1A to 1F). In response to verification of a first verification factor (e.g., the user supplied their correct username/password), the web page 411 may briefly display an optical label 442 in a manner that is not visible to the user but detectable from the image data captured by the image camera(s) of the wearable device 402. For example, the optical label 442 is displayed on the computing device during a time interval that is greater than a non-perception threshold such that the optical label 442 is not visible to a person, but detectable by the wearable device 402.

In some examples, the non-perception threshold is a critical flicker frequency (CFF). The human vision system has a limited detection ability of time variant fluctuation of light intensity. When the changes are above the CFF, the human vision system is not able to detect the changes (e.g., only the averaged luminance is perceived). Therefore, by inserting the optical label 442 (e.g., QR code, bar code, etc.) on a web page 411 in a time interval that is greater than the non-perception threshold (e.g., the CFF), the wearable device 402 can detect the optical label 442 without the optical label 442 being seen by the user. The detection of the optical label 442 may cause the wearable device 402 to obtain the authentication code 422 according to any of the techniques discussed herein. In some examples, the wearable device 402 may display the authentication code 422 on a display 418 of the wearable device 402. In some examples, in response to the detection of the optical label 442, the wearable device 402 may display an interface for receiving the authentication code 422, and the wearable device 402 may receive and display the authentication code 422 in the interface according to any of the techniques discussed herein.

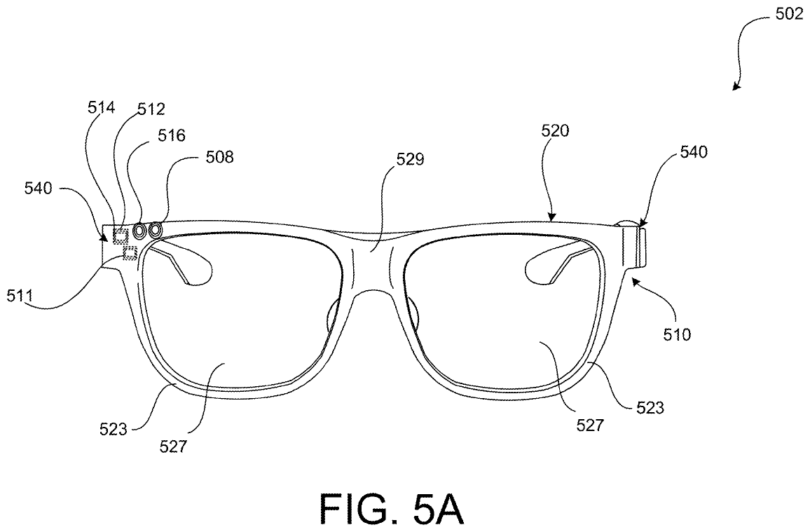

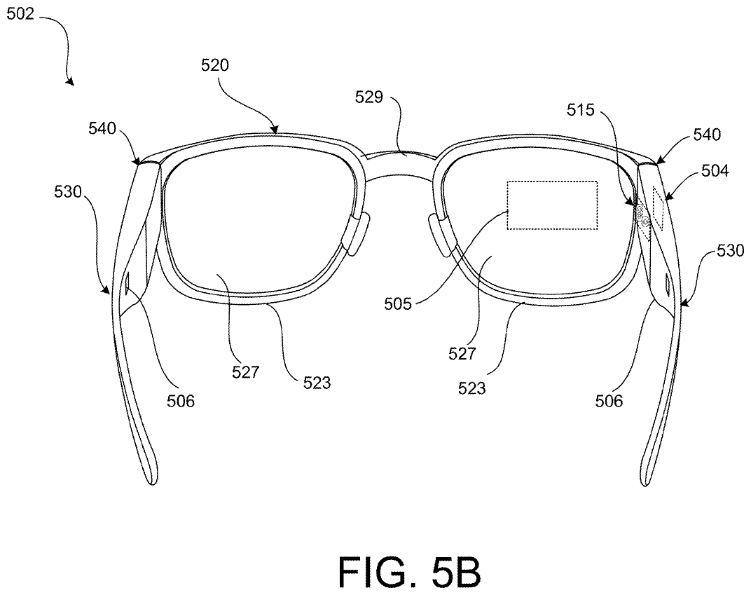

FIGS. 5A and 5B illustrate an example of a wearable device 502. The wearable device 502 may be an example of the wearable device 102 of FIGS. 1A to 1F, the wearable device 202 of FIGS. 2A and 2B, the wearable device 302 of FIG. 3, and/or the wearable device 402 of FIG. 4 and may include any of the details discussed with reference to those figures. The wearable device 502 may be a head-mounted wearable device, e.g., smart glasses or augmented reality glasses. The wearable device 502 may include display capability, computing/processing capability, and object tracking capability. FIG. 5A is a front view of the wearable device 502, and FIG. 5B is a rear view of the wearable device 502. Although an AR device is depicted in FIGS. 5A and 5B, it is noted that the techniques discussed herein may apply to a VR device as well.

The wearable device 502 includes a frame 510. The frame 510 includes a front frame portion 520, and a pair of arm portions 530 rotatably coupled to the front frame portion 520 by respective hinge portions 540. The front frame portion 520 includes rim portions 523 surrounding respective optical portions in the form of lenses 527, with a bridge portion 529 connecting the rim portions 523. The arm portions 530 are coupled, for example, pivotably or rotatably coupled, to the front frame portion 520 at peripheral portions of the respective rim portions 523. In some examples, the lenses 527 are corrective/prescription lenses. In some examples, the lenses 527 are an optical material including glass and/or plastic portions that do not necessarily incorporate corrective/prescription parameters.

In some examples, the wearable device 502 includes a display device 504 that can output visual content, for example, at a display 505 (e.g., an output coupler), so that the visual content is visible to the user. The display device 504 may be provided in one of the two arm portions 530, simply for purposes of discussion and illustration. Display devices 504 may be provided in each of the two arm portions 530 to provide for binocular output of content. In some examples, the display device 504 may be a see through near eye display. In some examples, the display device 504 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 527, next to content (e.g., the authentication code, digital images, user interface elements, virtual content, and the like) output by the display device 504. In some implementations, waveguide optics may be used to depict content on the display device 504.

In some examples, the wearable device 502 includes one or more audio output devices 506 (such as, for example, one or more speakers), an illumination device 508, a sensing system 511, a control system 512, at least one processor 514, and an outward facing image sensor 516 (for example, a camera). In some examples, the sensing system 511 may include various sensing devices and the control system 512 may include various control system devices including, for example, one or more processors 514 operably coupled to the components of the control system 512. In some examples, the control system 512 may include a communication module providing for communication and exchange of information between the wearable device 502 and other external devices (e.g., the computing device 130, the central server 170, the computing device 152 of FIG. 1A).

In some examples, the wearable device 502 includes a gaze tracking device 515 to detect and track eye gaze direction and movement. Data captured by the gaze tracking device 515 may be processed to detect and track gaze direction and movement as a user input. The gaze tracking device 515 is provided in one of the two arm portions 530, simply for purposes of discussion and illustration. In some examples, the gaze tracking device 515 is provided in the same arm portion 530 as the display device 504, so that user eye gaze can be tracked not only with respect to objects in the physical environment, but also with respect to the content output for display by the display device 504. In some examples, gaze tracking devices 515 may be provided in each of the two arm portions 530 to provide for gaze tracking of each of the two eyes of the user. In some examples, display devices 504 may be provided in each of the two arm portions 530 to provide for binocular display of visual content. In some examples, the wearable device 502 includes a head gaze point tracking device configured to calculate a head gaze point based on head orientation or head movement. A head gaze point is the point in space where a person is looking with their head. The head gaze point may be defined as the intersection of the line of sight of the two eyes. Head gaze points can be used to track where a person is looking and to infer their attention. The wearable device 502 may use cameras and/or sensors to track the movement of the head. The data from the cameras and/or sensors can be used to calculate the head gaze point.

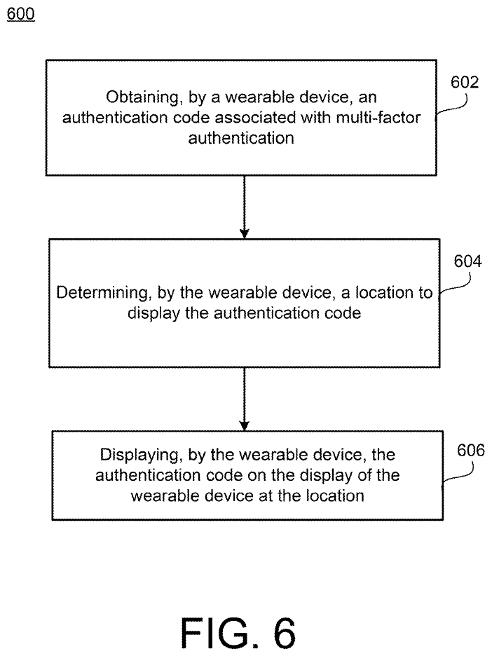

FIG. 6 illustrates a flowchart 600 depicting example operations of a system for multi-factor authentication using a wearable device. Although the flowchart 600 is described with reference to the system 100 of FIGS. 1A to 1F, the flowchart 600 may be applicable to any of the implementations disclosed herein. Although the flowchart 600 of FIG. 6 illustrates the operations in sequential order, it will be appreciated that this is merely an example, and that additional or alternative operations may be included. Further, operations of FIG. 6 and related operations may be executed in a different order than that shown, or in a parallel or overlapping fashion.

Operation 602 includes receiving, by a wearable device 102, an authentication code 122 associated with multi-factor authentication. Operation 604 includes determining, by the wearable device 102, a location 120 to display the authentication code 122. Operation 606 includes displaying, by the wearable device 102, the authentication code 122 on a display 118 of the wearable device 102 at the location 120.

According to some aspects, obtaining the authentication code associated with the multi-factor authentication includes receiving, via an image camera of the wearable device, image data and extracting the authentication code from the image data using optical character recognition. In some examples, obtaining the authentication code associated with the multi-factor authentication includes receiving the authentication code from a computing device communicatively coupled to the wearable device. In some examples, obtaining the authentication code associated with the multi-factor authentication includes receiving the authentication code from a central server. In some examples, the operations may include executing, by the wearable device, an authenticator application to obtain the authentication code. The location to display the authentication code may be determined based on a user interface (UI) element in an interface for receiving the authentication code.

The operations may include receiving, via an image camera of the wearable device, an optical label displayed on a computing device and identifying the UI element using the optical label, where the location of the authentication code is determined based on a position of the UI element in the interface. The optical label is displayed on the computing device during a time interval that is greater than a non-perception threshold such that the optical label is not visible to a person. The operations may include receiving, via an image camera of the wearable device, image data of at least a portion of the interface displayed by a computing device, and identifying the UI element using the image data, where the location of the authentication code is determined based on a position of the UI element in the interface. The operations may include determining, by the wearable device, a depth value between a portion of the wearable device and a portion of a computing device and determining, by the wearable device, a font size of the authentication code, wherein the authentication code is displayed with the font size. The authentication code may include a first portion and a second portion, and the operations may include displaying the first portion of the authentication code on the display of the wearable device and aligning, using the wearable device, the first portion of the authentication code with the second portion of the authentication code that is displayed by a computing device.

According to an aspect, a wearable device includes at least one processor and a non-transitory computer-readable medium storing executable instructions that cause the at least one processor to obtain an authentication code associated with multi-factor authentication, determine a location to display the authentication code, and display the authentication code at the location on a display of the wearable device or a display of a first computing device.

According to some aspects, the executable instructions include instructions that cause the at least one processor to receive, via an image camera of the wearable device, image data of the authentication code displayed by a second computing device and extract the authentication code from the image data using optical character recognition. The executable instructions include instructions that cause the at least one processor to receive the authentication code from the first computing device, the second computing device, or a central server. The executable instructions include instructions that cause the at least one processor to execute an authenticator application to obtain the authentication code. The executable instructions include instructions that cause the at least one processor to receive, via an image camera of the wearable device, an optical label displayed on the first computing device and identifying a user interface (UI) element in an interface associated with the optical label using the optical label, where the location of the authentication code is determined based on a position of the UI element in the interface.

The executable instructions include instructions that cause the at least one processor to receive, via an image camera of the wearable device, image data of at least a portion of an interface displayed by the first computing device and identifying a user interface (UI) element in the interface using the image data, where the location of the authentication code is determined based on a position of the UI element in the interface. The executable instructions include instructions that cause the at least one processor to transmit information that includes the authentication code to the first computing device, the information configured to cause the first computing device to display the authentication code in a code entry field.

According to an aspect, a non-transitory computer-readable medium storing executable instructions that cause at least one processor to execute operations, where the operations include detecting, by a wearable device, an authentication request associated with multi-factor authentication, in response to the authentication request, displaying a gaze interface on a display of the wearable device, receiving, via the gaze interface, a plurality of gaze gestures, determining whether to the plurality of gaze gestures correspond to a stored pattern of eye gestures, and, in response to the plurality of gaze gestures being determined as corresponding to the stored pattern of eye gestures, authenticating the authentication request.

In some examples, the operations include receiving, via an image camera of the wearable device, an optical label that is displayed on a first computing device, and, in response to the optical label, detecting the authentication request.

Clause 1. A computer-implemented method comprising: receiving, by a wearable device, an authentication code associated with multi-factor authentication; determining, by the wearable device, a location to display the authentication code; and displaying, by the wearable device, the authentication code on a display of the wearable device at the location.

Clause 2. The computer-implemented method of clause 1, wherein receiving the authentication code associated with the multi-factor authentication includes: receiving, via an image camera of the wearable device, image data; and extracting the authentication code from the image data using optical character recognition.

Clause 3. The computer-implemented method of clause 1 or 2, wherein receiving the authentication code associated with the multi-factor authentication includes: receiving the authentication code from a computing device communicatively coupled to the wearable device.

Clause 4. The computer-implemented method of any of clauses 1 to 3, wherein receiving the authentication code associated with the multi-factor authentication includes: receiving the authentication code from a server.

Clause 5. The computer-implemented method of any of clauses 1 to 4, further comprising: executing, by the wearable device, an authenticator application; and receiving the authentication code from the authenticator application.

Clause 6. The computer-implemented method of any of clauses 1 to 5, wherein the location to display the authentication code is determined based on a user interface (UI) element in an interface for receiving the authentication code.

Clause 7. The computer-implemented method of clause 6, further comprising: receiving, via an image camera of the wearable device, an optical label displayed on a computing device; and identifying the UI element using the optical label, wherein the location of the authentication code is determined based on a position of the UI element in the interface.

Clause 8. The computer-implemented method of clause 7, wherein the optical label is displayed on the computing device during a time interval that is greater than a non-perception threshold such that the optical label is not visible to a person.

Clause 9. The computer-implemented method of clause 6, further comprising: receiving, via an image camera of the wearable device, image data of at least a portion of the interface displayed by a computing device; and identifying the UI element using the image data, wherein the location of the authentication code is determined based on a position of the UI element in the interface.

Clause 10. The computer-implemented method of any of clauses 1 to 9, further comprising: determining, by the wearable device, a depth value between a portion of the wearable device and a portion of a computing device; and determining, by the wearable device, a font size of the authentication code based on the depth value, wherein the authentication code is displayed with the font size.

Clause 11. The computer-implemented method of any of clauses 1 to 10, further comprising: displaying a first portion of the authentication code on the display of the wearable device; and aligning, based on head movement, the first portion of the authentication code with a second portion of the authentication code that is displayed by a computing device.

Clause 12. A wearable device comprising: at least one processor; and a non-transitory computer-readable medium storing executable instructions that cause the at least one processor to: receive an authentication code associated with multi-factor authentication; determine a location to display the authentication code; and display the authentication code at the location on a display of the wearable device or a display of a first computing device.

Clause 13. The wearable device of clause 12, wherein the executable instructions include instructions that cause the at least one processor to: receive, via an image camera of the wearable device, image data of the authentication code displayed by a second computing device; and extract the authentication code from the image data using optical character recognition.

Clause 14. The wearable device of clause 13, wherein the executable instructions include instructions that cause the at least one processor to: receive the authentication code from the first computing device, the second computing device, or a server.

Clause 15. The wearable device of any of clauses 12 to 14, wherein the executable instructions include instructions that cause the at least one processor to: execute an authenticator application; and receive the authentication code from the authenticator application.

Clause 16. The wearable device of any of clauses 12 to 15, wherein the executable instructions include instructions that cause the at least one processor to: receive, via an image camera of the wearable device, an optical label displayed on the first computing device; and identify a user interface (UI) element in an interface associated with the optical label using the optical label, wherein the location of the authentication code is determined based on a position of the UI element in the interface.

Clause 17. The wearable device of any of clauses 12 to 16, wherein the executable instructions include instructions that cause the at least one processor to: receive, via an image camera of the wearable device, image data of at least a portion of an interface displayed by the first computing device; and identifying a user interface (UI) element in the interface using the image data, wherein the location of the authentication code is determined based on a position of the UI element in the interface.

Clause 18. The wearable device of any of clauses 12 to 17, wherein the executable instructions include instructions that cause the at least one processor to: transmit information that includes the authentication code to the first computing device, the information configured to cause the first computing device to display the authentication code in a code entry field.

Clause 19. A non-transitory computer-readable medium storing executable instructions that cause at least one processor to execute operations, the operations comprising: detecting, by a wearable device, an authentication request associated with multi-factor authentication; in response to the authentication request, displaying a gaze interface on a display of the wearable device; receiving, via the gaze interface, a plurality of gaze gestures; determining whether to the plurality of gaze gestures correspond to a stored pattern of eye gestures; and in response to the plurality of gaze gestures being determined as corresponding to the stored pattern of eye gestures, authenticating the authentication request.

Clause 20. The non-transitory computer-readable medium of clause 19, further comprising: receiving, via an image camera of the wearable device, an optical label that is displayed on a first computing device; and in response to the optical label, detecting the authentication request.

Clause 21. A computer-implemented method comprising: receiving, by a head-mounted display device, an authentication code associated with multi-factor authentication; receiving image data from an image camera on the head-mounted display device; detecting, by the head-mounted display device, that the image data includes an interface for receiving the authentication code; and displaying, by the head-mounted display device, the authentication code at a location that corresponds to the interface.

Clause 22. The computer-implemented method of clause 21, wherein the image data is first image data, wherein receiving the authentication code associated with the multi-factor authentication includes: detecting the authentication code from second image data received from the image camera.

Clause 23. The computer-implemented method of clause 21, wherein receiving the authentication code associated with the multi-factor authentication includes: receiving the authentication code from a computing device communicatively coupled to the head-mounted display device.

Clause 24. The computer-implemented method of clause 21, wherein receiving the authentication code associated with the multi-factor authentication includes: receiving the authentication code from a server computer.

Clause 25. The computer-implemented method of clause 21, wherein receiving the authentication code associated with the multi-factor authentication includes: receiving the authentication code from an authenticator application executing on the head-mounted display device.

Clause 26. The computer-implemented method of any one of clauses 21 to 25, further comprising: estimating a position of the interface in three-dimensional (3D) space based on the image data, wherein the authentication code is displayed at the position.

Clause 27. The computer-implemented method of any one of clauses 21 to 26, wherein the authentication code is configured to be anchored to the location regardless of head movements.

Clause 28. The computer-implemented method of any one of clauses 21 to 27, wherein the interface includes a code entry field, wherein the authentication code is positioned at a location outside of the code entry field.

Clause 29. The computer-implemented method of any one of clauses 21 to 28, wherein the image data is first image data, further comprising: detecting that a character of the authentication code is entered on the interface based on second image data from the image camera; and adjusting a display appearance of the character based on whether or not the character is accurate.

Clause 30. The computer-implemented method of any one of clauses 21 to 29, further comprising: determining, by the head-mounted display device, a depth value of the interface; and determining, by the head-mounted display device, a font size of the authentication code based on the depth value, wherein the authentication code is displayed with the font size.

Clause 31. The computer-implemented method of any one of claims 21 to 30, further comprising: displaying a first portion of the authentication code on the head-mounted display device; and aligning, based on head movement, the first portion of the authentication code with a second portion of the authentication code that is displayed by a computing device.

Clause 32. A head-mounted display device storing executable instructions that cause at least one processor to execute any one of clauses 21 to 31.

Clause 33. A head-mounted display device including at least one processor and a non-transitory computer-readable medium storing executable instructions that cause the at least one processor to execute operations, the operations comprising: receiving, by a head-mounted display device, an authentication code associated with multi-factor authentication; receiving image data from an image camera on the head-mounted display device; detecting, by the head-mounted display device, that the image data includes an interface for receiving the authentication code; and displaying, by the head-mounted display device, the authentication code at a location that corresponds to the interface.

Clause 34. The head-mounted display device of clause 33, wherein the image data is first image data, wherein receiving the authentication code associated with the multi-factor authentication includes: detecting the authentication code from second image data received from the image camera.

Clause 35. The head-mounted display device of clause 33, wherein receiving the authentication code associated with the multi-factor authentication includes: receiving the authentication code from a computing device communicatively coupled to the head-mounted display device.

Clause 36. The head-mounted display device of clause 33, wherein receiving the authentication code associated with the multi-factor authentication includes: receiving the authentication code from a server computer.

Clause 37. The head-mounted display device of clause 33, wherein receiving the authentication code associated with the multi-factor authentication includes: receiving the authentication code from an authenticator application executing on the head-mounted display device.

Clause 38. The head-mounted display device of any one of clauses 33 to 37, further comprising: estimating a position of the interface in three-dimensional (3D) space based on the image data, wherein the authentication code is displayed at the position.

Clause 39. The head-mounted display device of any one of clauses 33 to 38, wherein the authentication code is configured to be anchored to the location regardless of head movements.

Clause 40. The head-mounted display device of any one of clauses 33 to 39, wherein the interface includes a code entry field, wherein the authentication code is positioned at a location outside of the code entry field.

Clause 41. The head-mounted display device of any one of clauses 33 to 40, wherein the image data is first image data, further comprising: detecting that a character of the authentication code is entered on the interface based on second image data from the image camera; and adjusting a display appearance of the character based on whether or not the character is accurate.

Clause 42. The head-mounted display device of any one of clauses 33 to 41, further comprising: determining, by the head-mounted display device, a depth value of the interface; and determining, by the head-mounted display device, a font size of the authentication code based on the depth value, wherein the authentication code is displayed with the font size.

Clause 43. The computer-implemented method of any one of claims 33 to 42, further comprising: displaying a first portion of the authentication code on the head-mounted display device; and aligning, based on head movement, the first portion of the authentication code with a second portion of the authentication code that is displayed by a computing device.

Clause 44. A computer-program product storing executable instructions that cause at least one processor to execute any one of clauses 21 to 31.

Clause 45. A method comprising: detecting, by a head-mounted display device, an authentication request; in response to the authentication request, displaying an interface; receiving, via the interface, a plurality of gestures; determining whether the plurality of gestures correspond to a stored pattern of gestures; and in response to the plurality of gestures being determined as corresponding to the stored pattern of gestures, authenticating the authentication request.

Clause 46. The method of clause 45, wherein the plurality of gestures includes eye gestures.

Clause 47. The method of clause 45, wherein the plurality of gestures includes head gestures.

Clause 48. The method of any of clauses 45 to 47, wherein detecting the authentication request includes receiving the authentication request from a computing device.

Clause 49. The method of any one of clauses 45 to 48, further comprising: receiving image data from an image camera on the head-mounted display device; detecting that the image data includes an optical label; and in response to the optical label, detecting the authentication request.

Clause 50. The method of clause 49, wherein the optical label is displayed on a computing device during a time interval that is greater than a non-perception threshold such that the optical label is not visible to a person.

Clause 51. A head-mounted display device storing executable instructions that cause at least one processor to execute any one of clauses 45 to 50.

Clause 52. A computer-program product storing executable instructions that cause at least one processor to execute any one of clauses 45 to 50.

Claim 53. A head-mounted display device including at least one processor and a non-transitory computer-readable medium storing executable instructions that cause the at least one processor to execute operations, the operations comprising: detecting, by a head-mounted display device, an authentication request; in response to the authentication request. displaying an interface; receiving, via the interface, a plurality of gestures; determining whether the plurality of gestures correspond to a stored pattern of gestures; and in response to the plurality of gestures being determined as corresponding to the stored pattern of gestures, authenticating the authentication request.

Clause 54. The head-mounted display device of clause 53, wherein the plurality of gestures includes eye gestures.

Clause 55. The method of clause 53, wherein the plurality of gestures includes head gestures.

Clause 56. The method of any of clauses 53 to 55, wherein detecting the authentication request includes receiving the authentication request from a computing device.

Clause 57. The method of any one of clauses 53 to 56, further comprising: receiving image data from an image camera on the head-mounted display device; detecting that the image data includes an optical label; and in response to the optical label, detecting the authentication request.

Clause 58. The method of clause 57, wherein the optical label is displayed on a computing device during a time interval that is greater than a non-perception threshold such that the optical label is not visible to a person.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. In addition, the term “module” may include software and/or hardware.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

1. A method comprising:
receiving, by a wearable device, an authentication code associated with multi-factor authentication;
receiving image data from a camera on the wearable device;
detecting, by the wearable device, that the image data includes an interface for receiving the authentication code; and
displaying, by the wearable device, the authentication code at a location that corresponds to the interface.

2. The method of claim 1, wherein the image data is first image data, wherein receiving the authentication code associated with the multi-factor authentication includes:
detecting the authentication code from second image data received from the camera.

3. The method of claim 1, wherein receiving the authentication code associated with the multi-factor authentication includes:
receiving the authentication code from a computing device communicatively coupled to the wearable device.

4. The method of claim 1, wherein receiving the authentication code associated with the multi-factor authentication includes:
receiving the authentication code from a server computer.

5. The method of claim 1, wherein receiving the authentication code associated with the multi-factor authentication includes:
receiving the authentication code from an authenticator application executing on the wearable device.

6. The method of claim 1, further comprising:
estimating a position of the interface in three-dimensional (3D) space based on the image data, wherein the authentication code is displayed at the position.

7. The method of claim 1, wherein the authentication code is configured to be anchored to the location regardless of head movements.

8. The method of claim 1, wherein the interface includes a code entry field, wherein the authentication code is positioned at a location outside of the code entry field.

9. The method of claim 1, wherein the image data is first image data, further comprising:
detecting that a character of the authentication code is entered on the interface based on second image data from the camera; and
adjusting a display appearance of the character based on whether or not the character is accurate.

10. The method of claim 1, further comprising:
determining, by the wearable device, a depth value of the interface; and
determining, by the wearable device, a font size of the authentication code based on the depth value, wherein the authentication code is displayed with the font size.

11. The method of claim 1, further comprising:
displaying a first portion of the authentication code on the wearable device; and
aligning, based on head movement, the first portion of the authentication code with a second portion of the authentication code that is displayed by a computing device.

12-21. (canceled)

22. A wearable device comprising:
at least one processor; and
a non-transistory computer-readable medium storing executable instructions that cause the at least one processor to:
receive an authentication code associated with multi-factor authentication;
receive image data from a camera on the wearable device;
detect that the image data includes an interface for receiving the authentication code; and
display the authentication code at a location that corresponds to the interface.

23. The wearable device of claim 22, wherein the image data is first image data, wherein the executable instructions include instructions that cause the at least one processor to:
detect the authentication code from second image data received from the camera.

24. The wearable device of claim 22, wherein the executable instructions include instructions that cause the at least one processor to:
receive the authentication code from a computing device communicatively coupled to the wearable device.

25. The wearable device of claim 22, wherein the executable instructions include instructions that cause the at least one processor to:
receive the authentication code from an authenticator application executing on the wearable device.

26. The wearable device of claim 22, wherein the executable instructions include instructions that cause the at least one processor to:
estimate a position of the interface in three-dimensional (3D) space based on the image data, wherein the authentication code is displayed at the position, wherein the authentication code is configured to be anchored to the location regardless of head movements.

27. The wearable device of claim 22, wherein the interface is a first interface, wherein the executable instructions include instructions that cause the at least one processor to:
detect an authentication request;
in response to the authentication request, display a second interface;
receive, via the second interface, a plurality of gestures, the plurality of gestures including eye gestures or head gestures;
determine whether the plurality of gestures correspond to a stored pattern of gestures; and
in response to the plurality of gestures being determined as corresponding to the stored pattern of gestures, authenticate the authentication request.

28. The wearable device of claim 27, wherein the image data is first image data, wherein the executable instructions include instructions that cause the at least one processor to:
receive second image data from the camera on the wearable device;
detect that the second image data includes an optical label; and
in response to the optical label, detect the authentication request.

29. A non-transitory computer-readable medium storing executable instructions that cause at least one processor to execute operations, the operations comprising:
receiving, by a wearable device, an authentication code associated with multi-factor authentication;
receiving image data from a camera on the wearable device;
detecting, by the wearable device, that the image data includes an interface for receiving the authentication code; and
displaying, by the wearable device, the authentication code at a location that corresponds to the interface.

30. The non-transitory computer-readable medium of claim 29, wherein the image data is first image data, wherein receiving the authentication code associated with the multi-factor authentication includes:
detecting the authentication code from second image data received from the camera.

31. The non-transitory computer-readable medium of claim 29, wherein the operations further comprise:
estimating a position of the interface in three-dimensional (3D) space based on the image data, wherein the authentication code is displayed at the position, wherein the authentication code is configured to be anchored to the location regardless of head movements, wherein the interface includes a code entry field, wherein the authentication code is positioned at a location outside of the code entry field.
